(19) United States
(12) Patent Application Publication
(10) Pub. No.: US 2021/0045963 A1
(43) Pub. Date: Feb. 18, 2021

(54) Massaging Glove Assembly

(71) Applicant: Gerardo Bravo, Bellflower, CA (US)

(72) Inventor: Gerardo Bravo, Bellflower, CA (US)

(21) Appl. No.: 16/539,745

(22) Filed: Aug. 13, 2019

(51) Int. Cl. A61H 15/00; A41D 19/00

(52) U.S. Cl. CPC A61H 15/0085; A41D 19/0024; A61H 2201/0221; A61H 2201/165; A61H 2201/1635

(57) ABSTRACT

A massaging glove assembly for massaging a user's hand includes a glove that is wearable on a user's hand. A plurality of massage units is each integrated into the glove. Each of the massage units is positioned at strategic locations on the glove to massage locations on the user's hand associated with therapeutic massage. An electronic device is included that is in wireless communication with the massage units for remotely turning the massage units on and off.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to massaging devices and more particularly pertains to a new massaging device for massaging a user's hand.

### (2) Description of Related Art Including Information Disclosed Under 37 CFR 1.97 and 1.98

The prior art relates to massaging devices.

### BRIEF SUMMARY OF THE INVENTION

An embodiment of the disclosure meets the needs presented above by generally comprising a glove that is wearable on a user's hand. A plurality of massage units is each integrated into the glove. Each of the massage units is positioned at strategic locations on the glove to massage locations on the user's hand associated with therapeutic massage. An electronic device is included that is in wireless communication with the massage units for remotely turning the massage units on and off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a massaging glove assembly according to an embodiment of the disclosure.

FIG. 2 is a top phantom view of an embodiment of the disclosure.

FIG. 3 is a bottom phantom view of an embodiment of the disclosure.

FIG. 4 is a left side phantom view of an embodiment of the disclosure.

FIG. 5 is a detail view taken from circle 5 of FIG. 1 of an embodiment of the disclosure.

FIG. 6 is a detail view taken from circle 6 of FIG. 2 of an embodiment of the disclosure.

FIG. 7 is a cross sectional view taken along line 7-7 of FIG. 6 of an embodiment of the disclosure.

FIG. 8 is a cross sectional view taken along line 8-8 of FIG. 6 of an embodiment of the disclosure.

### DETAILED DESCRIPTION OF THE INVENTION

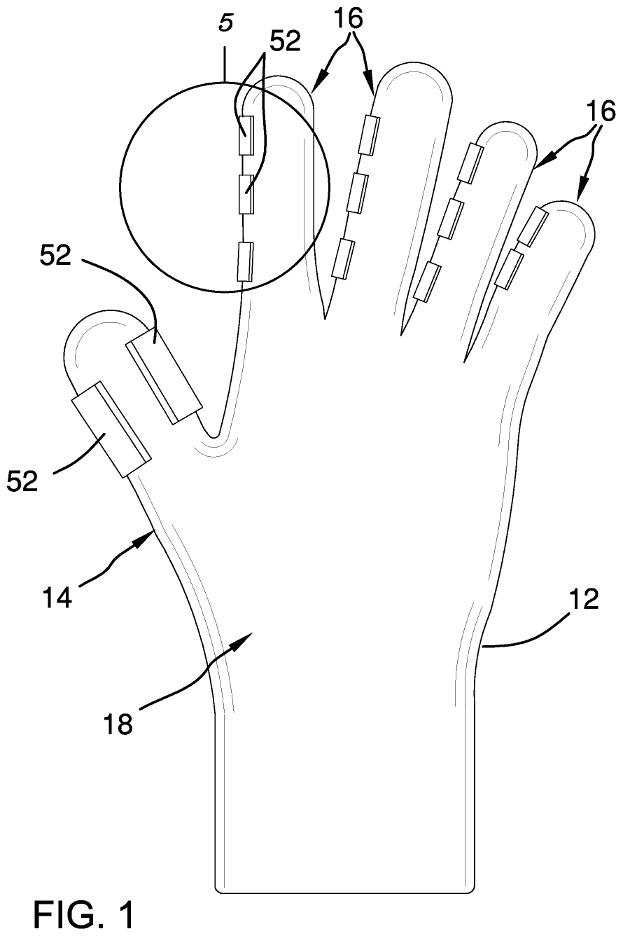

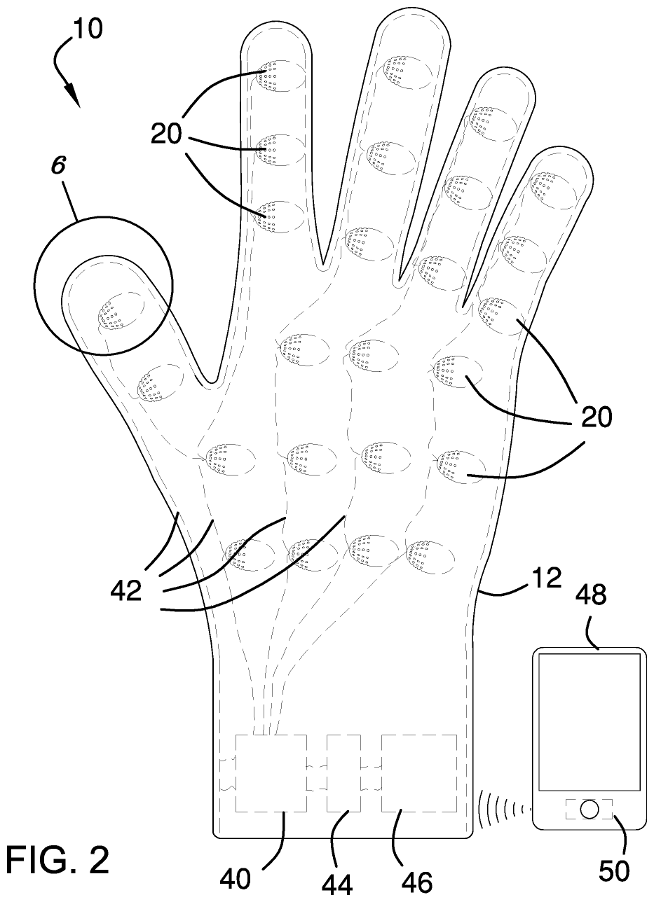

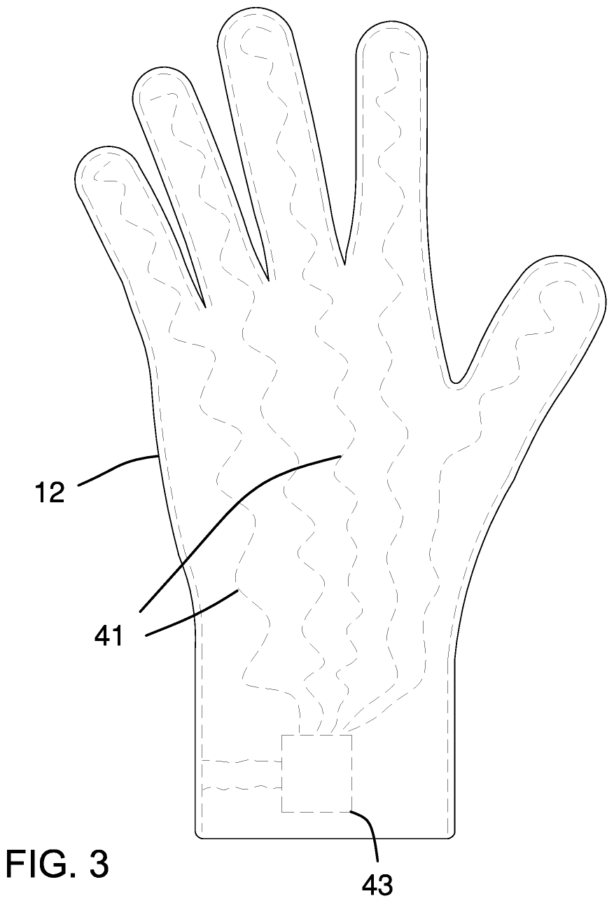

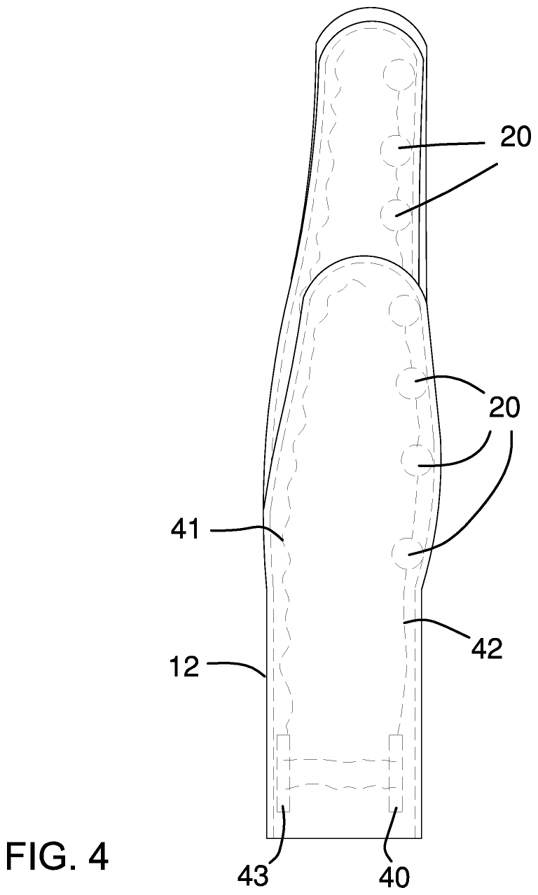

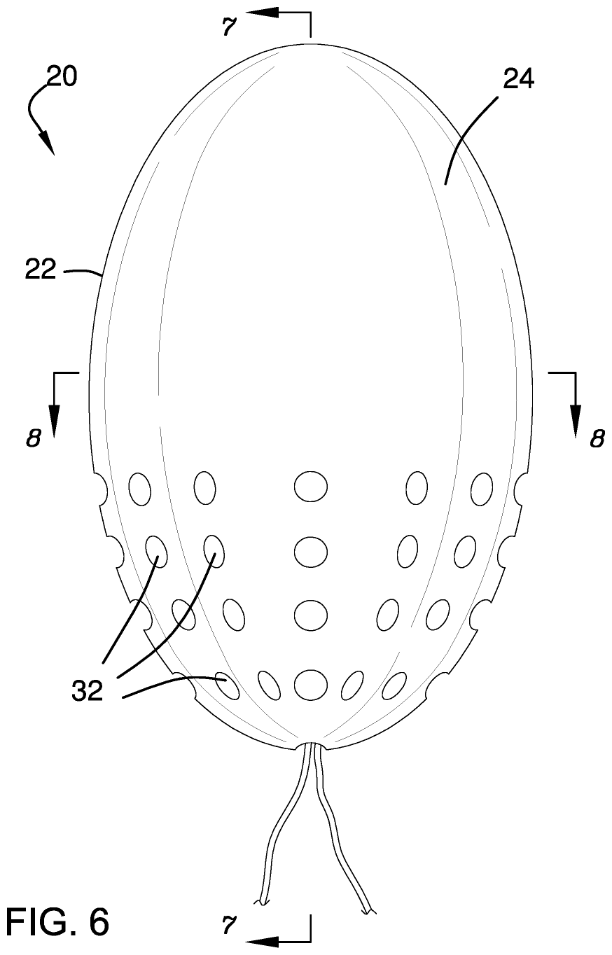

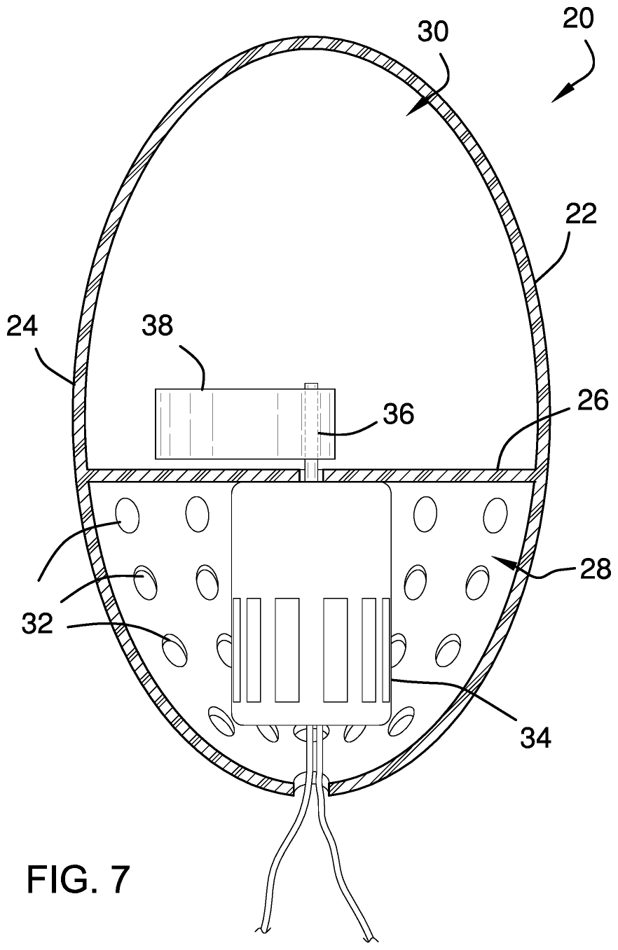

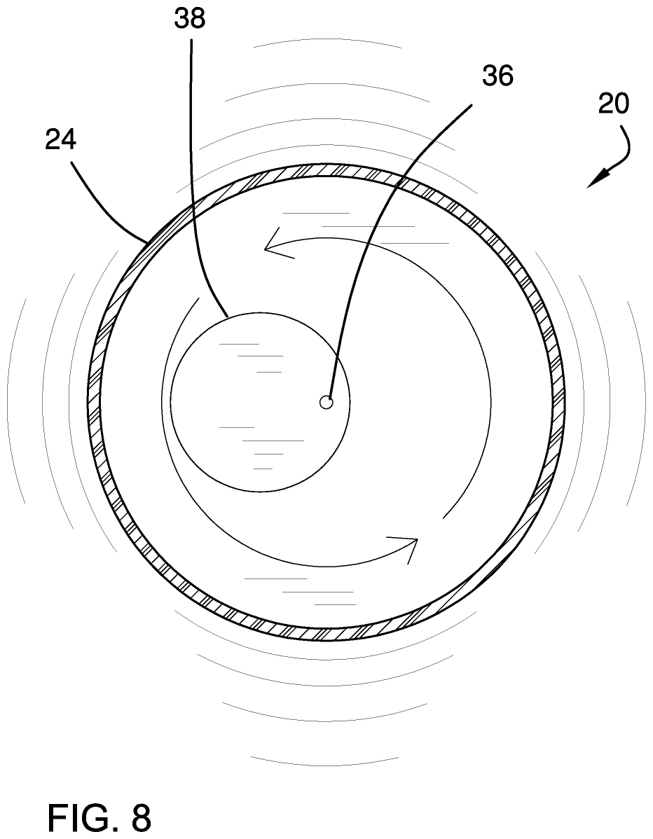

With reference now to the drawings, and in particular to FIGS. 1 through 8 thereof, a new massaging device embodying the principles and concepts of an embodiment of the disclosure and generally designated by the reference numeral 10 will be described.

As best illustrated in FIGS. 1 through 8, the massaging glove assembly 10 generally comprises a glove 12 that is wearable on a user's hand. The glove 12 has a thumb portion 14, a plurality of finger portions 16 and a hand portion 18 each receiving a respective one of the user's thumb, fingers and hand. The glove 12 may be manufacture in a variety of sizes for accommodating varies hand sizes.

A plurality of massage units 20 is provided and each of the massage units 20 is integrated into the glove 12. Each of the massage units 20 is positioned at strategic locations on the glove 12 to massage locations on the user's hand associated with therapeutic massage. Each of the massage units 20 comprises a ball 22 that has an outer wall 24. The ball 22 is hollow and the ball 22 has a divider 26 positioned therein to define a motor chamber 28 and a cam chamber 30 within the ball 22. The outer wall 24 has a plurality of apertures 32 each extending into the motor chamber 28 for ventilating the motor chamber 28.

Each of the massage units 20 includes a motor 34 that is positioned within the motor chamber 28. The motor 34 has a drive shaft 36 extending through the divider 26 and into the cam chamber 30. Each of the massage units 20 includes a cam 38 that is coupled to the drive shaft 36 such that the motor 34 rotates the cam 38 when the motor 34 is turned on. The cam 38 is offset from a rotational axis of the drive shaft 36 such that the cam 38 orbits within the cam chamber 30 to generate inertia for massaging the user's hand. The motor 34 may be an electric motor or the like.

A control circuit 40 is integrated into the glove 12 and the control circuit 40 receives an on input and an off input. An array of conductors 42 is integrated into the glove 12. The array of conductors 42 is electrically coupled between the control circuit 40 and the motor 34 in each of the massage units 20. The motor 34 in each of the massage units 20 is turned on when the control circuit 40 receives the on input. Additionally, the motor 34 in each of the massage units 20 is turned off when the control circuit 40 receives the off input.

A receiver 44 is integrated into the glove 12 and the receiver 44 is electrically coupled to the control circuit 40. The receiver 44 may be a radio frequency receiver or the like and the receiver 44 may employ Bluetooth communication protocols. A power supply 46 is integrated into the glove 12, the power supply 46 is electrically coupled to the control circuit 40 and the power supply 46 comprises at least one battery.

A heating element 41 is integrated into the glove 12 such that the heating element 41 is in thermal communication with the glove 12. The heating element 41 is electrically coupled to the control circuit 40 and the heating element 41 is turned on when the control circuit 40 receives the heat input. The heating element 41 may comprise a plurality of electric heating coils that are distributed throughout the glove. A thermostat 43 is integrated into the glove 12 and the thermostat 43 is electrically coupled to the control circuit 40. The thermostat 43 is in thermal communication with the heating element 41 and the thermostat 43 turns off the heating element 41 when the heating element 41 reaches a predetermined maximum temperature. The thermostat 43 may be an electronic thermostat or the like and the predetermined maximum temperature may be approximately 120.0 degrees Fahrenheit.

An electronic device 48 is included and the electronic device 48 is in wireless communication with the massage units 20 for remotely turning the massage units 20 on and off. The electronic device 48 has a transceiver 50 and the transceiver 50 is in wireless electrical communication with the receiver 44. The control circuit 40 receives the on input when the electronic device 48 broadcasts an on command and the control circuit 40 receives the off input when the electronic device 48 broadcasts an off command. Additionally, the control circuit 40 receives the heat input when the electronic device 48 broadcasts a heat command. The transceiver 50 may be a radio frequency transceiver or the like and the transceiver 50 may employ Bluetooth communication protocols. Additionally, the electronic device 48 may be a smart phone, a tablet or any other personal electronic device 48 that has wireless communication capabilities.

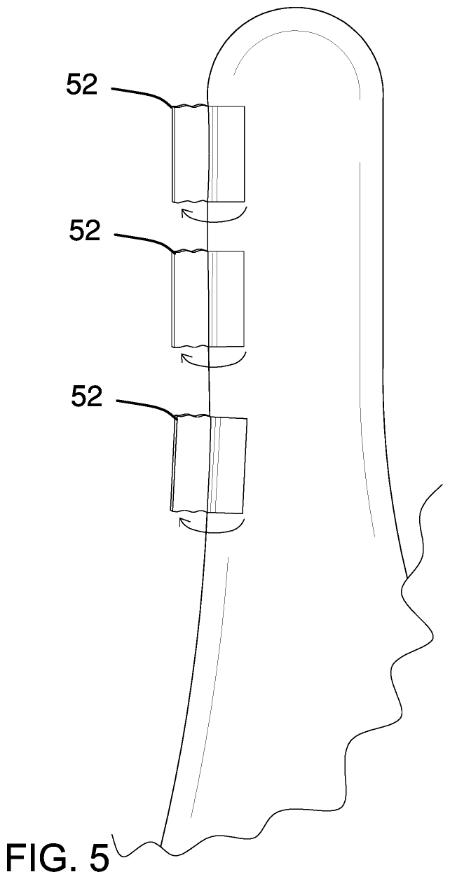

As is most clearly shown in FIGS. 1 and 5, the glove 12 may include a plurality of flaps 52 and each of the flaps 52 may be aligned with a respective one of the massage units 20. Each of the flaps 52 can be opened to access the respective massage unit 20. Additionally, each of the flaps 52 can be closed to cover the respective massage unit 20.

In use, the electronic device 48 is synched with the receiver 44 in the glove 12 for controlling the massage units 20. The glove 12 is worn and the electronic device 48 is manipulated to turn on each of the massage units 20. In this way the user's hand is massaged for relieving pain and tension in the user's hand. The electronic device 48 is manipulated to turn off each of the massage units 20 when the user wishes to remove the glove 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A massaging glove assembly being configured to massage a user's hand, said assembly comprising:
a glove being wearable on a user's hand, said glove having a thumb portion, a plurality of finger portions and a hand portion each receiving a respective one of the user's thumb, fingers and hand;
a plurality of massage units, each of said massage units being integrated into said glove, each of said massage units being positioned at strategic locations on said glove wherein each of said massage units is configured to massage locations on the user's hand associated with therapeutic massage; and
an electronic device being in wireless communication with said massage units for remotely turning said massage units on and off.

2. The assembly according to claim 1, wherein each of said massage units comprises a ball having an outer wall, said ball being hollow, said ball having a divider being positioned therein to define a motor chamber and a cam chamber within said ball, said outer wall having a plurality of apertures each extending into said motor chamber for ventilating said motor chamber.

3. The assembly according to claim 2, wherein each of said massage units includes a motor being positioned within said motor chamber, said motor having a drive shaft extending through said divider and into said cam chamber.

4. The assembly according to claim 3, wherein each of said massage units includes a cam being coupled to said drive shaft such that said motor rotates said cam when said motor is turned on, said cam being offset from a rotational axis of said drive shaft such that said cam orbits within said cam chamber to generate inertia for massaging the user's hand.

5. The assembly according to claim 3, further comprising a control circuit being integrated into said glove, said control circuit receiving an on input and an off input.

6. The assembly according to claim 5, further comprising an array of conductors being integrated into said glove, said array of conductors being electrically coupled between said control circuit and said motor in each of said massage units, said motor in each of said massage units being turned on when said control circuit receives said on input, said motor in each of said massage units being turned off when said control circuit receives said off input.

7. The assembly according to claim 6, further comprising a receiver being integrated into said glove, said receiver being electrically coupled to said control circuit.

8. The assembly according to claim 7, further comprising a power supply being integrated into said glove, said power supply being electrically coupled to said control circuit, said power supply comprising at least one battery.

9. The assembly according to claim 7, wherein said electronic device has a transceiver, said transceiver being in wireless electrical communication with said receiver, said control circuit receiving said on input when said electronic device broadcasts an on command, said control circuit receiving said off input when said electronic device broadcasts an off command.

10. A massaging glove assembly being configured to massage a user's hand, said assembly comprising:
a glove being wearable on a user's hand, said glove having a thumb portion, a plurality of finger portions and a hand portion each receiving a respective one of the user's thumb, fingers and hand;
a plurality of massage units, each of said massage units being integrated into said glove, each of said massage units being positioned at strategic locations on said glove wherein each of said massage units is configured to massage locations on the user's hand associated with therapeutic massage, each of said massage units comprising:
a ball having an outer wall, said ball being hollow, said ball having a divider being positioned therein to define a motor chamber and a cam chamber within said ball, said outer wall having a plurality of apertures each extending into said motor chamber for ventilating said motor chamber;
a motor being positioned within said motor chamber, said motor having a drive shaft extending through said divider and into said cam chamber; and
a cam being coupled to said drive shaft such that said motor rotates said cam when said motor is turned on, said cam being offset from a rotational axis of said drive shaft such that said cam orbits within said cam chamber to generate inertia for massaging the user's hand;
a control circuit being integrated into said glove, said control circuit receiving an on input, an off input and a heat input;
an array of conductors being integrated into said glove, said array of conductors being electrically coupled between said control circuit and said motor in each of said massage units, said motor in each of said massage units being turned on when said control circuit receives said on input, said motor in each of said massage units being turned off when said control circuit receives said off input;
a receiver being integrated into said glove, said receiver being electrically coupled to said control circuit;
a heating element being integrated into said glove such that said heating element is in thermal communication with said glove, said heating element being electrically coupled to said control circuit, said heating element being turned on when said control circuit receives said heat input;
a thermostat being integrated into said glove, said thermostat being electrically coupled to said control circuit, said thermostat being in thermal communication with said heating element, said thermostat turning said heating element off when said heating element reaches a predetermined maximum temperature;
a power supply being integrated into said glove, said power supply being electrically coupled to said control circuit, said power supply comprising at least one battery;
an electronic device being in wireless communication with said massage units for remotely turning said massage units on and off, said electronic device having a transceiver, said transceiver being in wireless electrical communication with said receiver, said control circuit receiving said on input when said electronic device broadcasts an on command, said control circuit receiving said off input when said electronic device broadcasts an off command.
